(19) United States
(12) Patent Application Publication
(10) Pub. No.: US 2008/0144724 A1
(43) Pub. Date: Jun. 19, 2008

(54) METHOD FOR PROTECTING VIDEO TRANSMISSION BASED ON H.264

(75) Inventors: Zhong LUO, Guangdong Province (CN); Bin Song, Guanggdong Province (CN); Ningzhao Zhou, Guangdong Province (CN); Yilin Chang, Guangdong Province (CN)

Correspondence Address: LADAS & PARRY, 5670 WILSHIRE BOULEVARD, SUITE 2100, LOS ANGELES, CA, 90036-5679, US

(73) Assignee: HUAWEI TECHNOLOGIES CO., LTD., Guangdong Province (CN)

(21) Appl. No.: 11/868,077

(22) Filed: Oct. 5, 2007

Related U.S. Application Data
(63) Continuation of application No. PCT/CN2006/000536, filed on Mar. 29, 2006.

(30) Foreign Application Priority Data
Apr. 8, 2005 (CN) 200510034127.6

(51) Int. Cl. H04N 7/24

(52) U.S. Cl. 375/240.26; 375/E07.001

(57) ABSTRACT

A method for protecting video transmission based on H.264 is disclosed, In the invention, a receiving end performs statistical analysis on the communication quality and the result is fed back to a transmitting end, the transmitting end adjusts the protection strategy self adaptively; the receiving end performs statistical analysis on the accumulated lost slice rate and position information about lost data based on the discontinuous situation of NALU sequence numbers; the receiving end feeds the statistical information back to the transmitting end with extended SEI message; the transmitting end configures two sets of protection strategy systems to separately protect critical data and non critical data, and selects the protection strategy of appropriate level according to the accumulated lost slice rate that is fed back; the receiving end transmits position information about lost data back to the transmitting end; the transmitting end resends the lost data.

### CROSS-REFERENCES TO RELATED APPLICATIONS

The present application is a continuation of PCT application PCT/CN2006/000536, filed on Mar. 29, 2006, entitled “Video Transmission Protection Method Based on H.264”, which is incorporated by reference herein in its entirety.

### FIELD OF THE INVENTION

The present invention relates to the technical field of video transmission protection, particularly to a method for protecting video transmission based on H.264 video compression coding standard.

### BACKGROUND OF THE INVENTION

Video Compression Coding Standard H.264, which is developed by the International Telecommunication Union Telecommunication Standardization Sector (ITU-T), International Organization for Standardization (ISO) and Moving Picture Expert Group (MPEG) of International Electrotechnical Commission (IEC), now gradually becomes a mainstream standard in the multimedia communication. Multimedia real-time communication products that largely adopt H.264 standard, such as Video Conferencing, Visual Telephony, 3rd Generation (3G) mobile communication terminal and network stream media products, successively appear. In the market, whether supporting H.264 has become the key factor that determines the competitive power of a product. Especially, with the appearance of 3G mobile communication system and the rapid development of Internet Protocol (IP) network, video communication gradually becomes one of the main communication services. After developing the H.261, H.263, H.263+etc., ITU-T officially released H.264 in 2003, which is also the main content of MPEG-4 Part 10. The specification of H.264 standard effectively improves the video coding efficiency and network adaptation. With the popularization and use of H.264, multimedia communication of IP network and mobile wireless network come into a new stage of fast development.

However, since H.264 uses many kinds of high efficient coding algorithms, so that the sensitivity of video code stream to channel error is increased, even a single primary error may lead to a sharp quality reduction of video. For example, in the IP network, although a plurality of management strategies of Quality of Service (QoS) on the bearer layer are adopted, there exists inevitably network bandwidth fluctuation, which leads to the frequent appearance of problems such as packet loss and packet delay. The transmission error caused by such problems is called erasure error. Different from the erasure error, there exists random bit error in a traditional circuit switched network. Comparing with the random bit error, it is more difficult to prevent and correct the erasure error. In H.264 video communication, the erasure error caused by packet loss etc. may lead to a very serious degradation of the image quality, or even lead to the breakdown of the system on the decoding end. Compared with other video coding standard, H.264 has more powerful capability, higher efficiency and more abundant functions; however, the bearing capability with respect to the erasure error is lower. Therefore, in the video communication based on the H.264 standard, effective technologies for preventing the erasure error such as packet loss from occurring should be adopted, so as to ensure the quality of the restored image in combination with many kinds of error-resilient technologies for video transport.

Traditional anti packet loss technologies include Erasure Codes, Automatic Retransmission Request (ARQ), Interleaving and so on, wherein the Erasure Codes are widely used. In the technology of the so-called Erasure Codes, a data code stream is sequentially and piecewise divided into units of the same size, known as data nodes, and then check nodes are generated from the data nodes according to a operation rule. In order to enhance the protection capability, the check nodes in a previous layer may be used in computation to generate check nodes in a subsequent layer, so as to obtain multi layer check nodes. In each layer, the number of the check nodes is reduced compared with the number of check nodes in the immediately preceding layer. Generally, the number of the check nodes is reduced proportionally. The Erasure Codes with higher coding efficiency have a lower complexity. For example, A notable a sub-class of erasure codes are called linear-time erasure codes because of linear complexity which is a linear function of the number of data nodes. The Erasure Codes with Linear-time are more useful in the real-time communication.

Tornado Codes are a kind of Erasure Codes with Linear-time, which are a new kind of Erasure Codes that are invented by Michael Luby, Michael Mitzenmacher, Amin Shokrollahi et al. around 1998. Tornado Codes have a simple structure, a high operation efficiency and a powerful protection capability. The Tornado Codes are widely applied in practical projects and are one of important technologies of error control coding in the multimedia transmission. The Tornado Codes are a kind of Erasure Codes with multilayer checking. A plurality of check node layers are generated layer by layer from the data nodes in the bottom layer. The check nodes and data nodes are all transmitted via a network from a transmitting end to a receiving end. If a part of the nodes are lost during the network transmission, the lost nodes may be recovered with the operation relationship between the upper layer and lower layer and the method for recovery based on other nodes which are not lost. This is the mechanism for data protection of Tornado Codes.

FIG. 1 shows the relationship among data nodes of Tornado Codes and check nodes in each layer. The lines between the nodes in FIG. 1 are referred to as edges, and the left node of an edge participates in calculating the right node of the edge. It can be seen that the relationship between the nodes in two consecutive layers is a many-to-many logical relationship. Given that the number of the data nodes is n, and the total number of the check nodes is m, then the code rate of the Erasure Codes is defined as r=n/(n+m) and the Redundancy rate is 1−r=m/(n+m). Under the same set of conditions (protection capability, resultant delay etc.), the higher the code rate is and the lower the redundancy rate is, then the higher the efficiency of the Erasure Codes is. The structure and performance of the Tornado Codes are mainly determined by three factors: (a) the number of the data nodes and the rule of layer-to-layer shrinking—generally it is a proportional shrinking; (b) the calculation method for generating the nodes in the next layer; (c) the relationship among the nodes in two adjacent layers.

The following relationship between each parameter of the Tornado Codes may be derived. Given that the number of the data nodes is n, the number of the check nodes is m, the shrinking rate is p, and the number of layers of the check nodes is i, then the number of the check nodes in the previous i−1 layers is respectively np, np², . . . , npⁱ⁻¹, and the number of the check nodes in the last layer, namely the i-th layer is npⁱ/(1−p), thus the total number of the nodes is n+m=n+n+np²+ . . . +npⁱ⁻¹+npⁱ/(1−p)=n/(1−p), then it is derived that m=np/(1−p), which is the implicit relationship between the shrinking rate and the check nodes. It should be ensured that the numbers of the nodes in each layer np, np², . . . , npⁱ⁻¹ and npⁱ/(1−p) are integers, then the feasible values of n may be calculated on the basis of the given i and p. For example, i=4, p=½, then it is derived that n should be multiples of 16.

In the process of generating Tornado Codes, the most common operation method is XOR operation, because the XOR operation has a very simple error recovery mechanism. For two bit sequences of the same size A=[a0, a1, a2, . . . , aL], B=[b0, b1, b2, . . . , bL], a bit sequence C of the same size is obtained by performing bitwise XOR operation, and there exists the following attribute: B is obtained by performing XOR operation between A and C, A is obtained by performing XOR operation between B and C. For the XOR operation among a plurality of sequences, there exists a corresponding recovery method. It can be seen that with the XOR operation, the interrelationship between the data nodes or the check nodes may be established. If any one of the nodes is lost, it may be recovered with other remaining nodes. Because the shrinking rate of the check nodes in the last layer is different, the calculation is performed by adopting a common error correcting coding strategy, such Reed-Solomon Codes.

Another important factor of the Tornado Codes is the interrelationship between consecutive layers, that is, a node in a subsequent layer is obtained by performing calculation with nodes in the previous layer. According to graph theory, a bipartite graph is formed among the nodes of two consecutive layers, two ends of any one of the edges are in the previous layer and the subsequent layer respectively. The nodes in the previous layer are also referred to as left nodes, and the nodes in the subsequent layer are referred to as right nodes. The number of the edges in connection with a node is referred to as degree. According to the random graph theory of Luby et al., it is proved mathematically that the parameter that determines the protection capability of the Tornado Codes is actually a vector of the degree of the nodes on two sides of the bipartite graph, which is formed by the previous and subsequent layers, and this degree vector is randomly generated. In the practical application, before Tornado coding, the random distribution of the node degree vector should firstly be determined, then the bipartite graphs of each level are generated according to the distribution by random matching. The interrelationship between the nodes in the previous and subsequent layers is determined according to the relevancy between the left and right nodes in the bipartite graph.

In the current Tornado Codes strategy, by setting the protection capability and other requirements such as the rationality of the number of the data nodes and the longest acceptable network delay, parameters n, m, i, p etc. are determined and the random distribution of node degree vector is given, and Tornado coding may be performed. During the decoding on the receiving end, according to the bipartite graph of each level, if a right node is received correctly, and only one node of the left nodes that are associated with the right node is lost, the lost node may be restored with the right node and all the left nodes that are not lost, that is, the effect of error correction is achieved.

Further, it is necessary to simply introduce the message constitution and transmission mechanism of the H.264 standard. In the H.264 standard, a layered mode is adopted, and Video Coding Layer (VCL) and Network Abstraction Layer (NAL) are defined. The latter is especially designed for network transmission, and is adaptable for the video transmission in various networks, so as to further increase the “affinity” of the network. An IP packet oriented coding mechanism is introduced in H.264, which is advantageous for the packet transmission in the network, and for supporting the video stream media transmission in the network. Further, this mechanism has a relatively strong anti error code characteristic, and is especially suitable for the wireless video transmission with high packet loss rate and serious interferences. In the H.264, all the data to be transmitted, including the image data and other messages, are packaged in packets of a uniform format, namely the network abstraction layer unit (NALU), for transmission. Each NALU is a variable length byte character string with certain syntax elements, and includes a header of one byte which is adapted to denote the type of the data, and includes load data of several integer bytes. An NALU may carry a coding slice or a parameter set of a sequence or image.

The H.264 data includes texture data, sequence parameter, image parameter and supplemental enhancement information (SEI) etc. of a reference frame, these data are critical data. In addition, the data also include texture data of a non reference frame and so on; these data are non critical data, or referred to as common data. SEI message is a general term of the messages which have an auxiliary effect in the decoding, displaying etc. of the H.264 video. In the prior art, various SEI messages are defined, and an SEI reserve message is reserved, so as to keep an extendable space for various possible applications in the future. According to H.264, the SEI message is not necessary for reconstructing the luminance and color of an image during the decoding process. For a decoder that conforms to the H.264 standard, it is unnecessary to perform any processing on SEI. That is, not all the terminals that conform to the basic requirements of the H.264 standard are able to process the SEI message. However, for a terminal that can not process the SEI message, SEI transmission has no influence on such terminal, because the terminal may simply ignore the SEI message that it is not able to process. According to the syntax rule of SEI, a user may transfer a customized message by utilizing the reserved message, so that the function extension may be realized.

At present_in the method for video transmission based on the H.264 standard, Tornado Erasure Codes with fixed parameters are generally adopted for protection.

In this method, it is firstly required to design the structure of the Tornado Codes according to the requirements of the application and the network situation. The number of the data nodes and the longest network delay etc. are determined according to the given protection capability and other requirements concerning audio, video type, ratio, etc., and thereby the parameters of the Tornado Codes, such as the number of data nodes n, the number of check nodes m, the number of check layers i, the shrinking rate p, are determined. After that, the random distribution of the node degree vectors in the bipartite graphs of each level is designed, and then the random bipartite graphs among the nodes of each level are generated by random matching.

When the communication begins, the video encoder on the transmitting end starts to generate a code stream. The data code stream that needs to be protected is divided into data units D₀, D₁, D₂, D₃, . . . , D_{T} of the same size, wherein the size of the data units is determined in the previous step.

From current point of time t, n data nodes Dₜ, Dₜ₊₁, . . . , Dₜ₊ₙ₋₁ are taken, wherein the initial value is t=0. Calculation is performed among correlative nodes according to the random bipartite graphs of each level generated previously, and the check nodes MC(1), MC(2), . . . , MC(i−1) of each layer and the last check node layer FC are generated level by level.

All the generated nodes, including the data nodes and check nodes, are transmitted to a receiving end in a network packetization mode, such as User Datagram Protocol (UDP)/IP or Transfer Control Protocol (TCP)/IP mode.

Then it is determined whether all the data nodes are processed, if yes, the transmission ends, otherwise, set t=t+n and return to process the next set of data nodes.

After receiving a set of data nodes and check nodes on the receiving end, it is firstly determined which nodes are lost, and then decoding is performed according to the normal decoding process of the Tornado Codes so as to restore those nodes that can be restored. The decoding and restoring process is repeated, until the communication ends.

It is to be noted that the step sequence given in the above video network transmission method is a logical sequence but not strict time sequence. In a real-time communication, the system often performs compression and encoding at the same time when performs transmission. The above steps may overlap in time.

In practical applications, for the above strategy there exist following problems: the network situation is variable and instable, the fluctuation of communication quality is dramatic, the occurrence situation of the transmission error such as packet loss is also variable, so that it is difficult for the fixed Tornado Codes protection strategy to adapt itself to the change of the network, or the protection is insufficient due to an inclement communication situation, which may lead to a degradation of the media quality or even lead to a breakdown of the decoding system, or the protection is excessive due to the improvement of communication situation, which may lead to a waste of the resources of encoding, processing and transmitting, and the efficiency of the system is decreased because of the excessive overhead.

The main reason that leads to such condition is protecting video communication stream with fixed Erasure Codes strategy can not adapt itself to the changes of the network communication.

### SUMMARY OF THE INVENTION

Therefore, the main object of the present invention is to provide a method for protecting video transmission based on H.264, so that the protection strategy of the video stream may be self adaptively adjusted according to the network communication status, so as to achieve a high efficient and high reliable video transmission.

To attain the above object, the present invention provides a method for protecting video transmission based on H.264, which includes:

protecting, by a transmitting end, video stream data according to a protection strategy, and transmitting the video stream data to a receiving end;

receiving, by the receiving end, the video stream data, obtaining information about communication quality according to the video stream data, and transmitting the information about the communication quality to the transmitting end;

receiving, by the transmitting end, the information about the communication quality, and adjusting the protection strategy accordingly.

Preferably, the obtaining information about communication quality includes: abstracting, by the receiving end, sequence numbers of network abstraction layer units from the video stream data received, performing a statistical analysis and obtaining an accumulated lost slice rate, which is used for indicating the information about the communication quality.

Preferably, the obtaining information about communication quality comprises: abstracting, by the receiving end, sequence numbers of network abstraction layer units from the video stream data received, taking a sequence number of a lost network abstraction layer unit as the information about communication quality; and

in the process of receiving, by the transmitting end, the information about communication quality, and adjusting the protection strategy accordingly, the transmitting end calculates and obtains an accumulated lost slice rate according to the sequence number of the lost network abstraction layer unit, and adjusts the protection strategy according to the accumulated lost slice rate.

Preferably, the transmitting end configures protection strategy systems of different levels, the adjusting in the process of receiving, by the transmitting end, the information about communication quality, and adjusting the protection strategy accordingly includes: selecting and implementing the protection strategy of a corresponding level according to the information about communication quality.

Preferably, the transmitting end configures a threshold sequence of the accumulated lost slice rate, and in the process of receiving, by the transmitting end, the information about communication quality, and adjusting the protection strategy accordingly, the protection strategy is adjusted according to a comparison relationship between the accumulated lost slice rate and the threshold sequence of the accumulated lost slice rate.

Preferably, the transmitting the information about the communication quality to the transmitting end includes: defining, by the receiving end, extended supplemental enhancement Information for carrying the information about communication quality, filling the information about communication quality in the extended supplemental enhancement information and transmitting the extended supplemental enhancement information back to the transmitting end.

Preferably, the protection strategy systems includes: a first protection strategy sequence, adapted to protect critical data of the video stream data; and a second protection strategy sequence, adapted to protect less critical data of the video stream data.

Preferably, the protection strategy adopts Tornado Erasure Codes, and the protection strategies of different levels correspond to the Tornado Codes with different parameters.

Preferably, the transmitting end configures a threshold sequence of an accumulated lost slice rate, the information about communication quality is the accumulated lost slice rate or a sequence number of a lost network abstraction layer unit; the adjusting in the process of receiving, by the transmitting end, the information about communication quality, and adjusting the protection strategy accordingly includes: selecting and implementing the protection strategy of the corresponding level according to the comparison relationship between the accumulated lost slice rate and the threshold sequence of the accumulated lost slice rate.

Preferably, the process of receiving, by the receiving end, the video stream data, obtaining information about communication quality according to the video stream data, and transmitting the information about communication quality to the transmitting end further includes: obtaining, by the receiving end, position information about lost video stream data through statistical analysis according to received sequence numbers of network abstraction layer units of the video stream data, and transmitting the position information back to the transmitting end; and

the process of receiving, by the transmitting end, the information about communication quality, and adjusting the protection strategy accordingly further includes: resending, by the transmitting end, the lost video stream data to the receiving end according to the position information about the lost video stream data.

By comparison, it may be found that the main difference between the technical strategy in the present invention and the prior art lies in: performing the statistical analysis of the communication quality by the receiving end and feeding back the result to the transmitting end, and adaptively adjusting the protection strategy by the transmitting end.

Such difference in the technical strategy brings about relatively evident advantageous effects, namely the statistic, feedback and adjustment mechanism is able to adapt itself to the requirements of network transmission precisely and in time, and the protection capability, system efficiency and reliability may be improved.

Further, in a preferred solution, the receiving end performs the statistical analysis of the accumulated lost slice rate and position information about lost data based on the discontinuous situation of the sequence numbers of NALUs. By performing the statistical analysis utilizing the sequence numbers of NALUs, it may be ensured that the statistical information is precise, and system resources may be saved.

Further, the receiving end feeds the statistical information back to the transmitting end with the extend SEI message. By transmitting with the extended SEI message, the overhead may be reduced, the mechanism may be simplified and system compatibility may be ensured.

The receiving end configures two sets of protection strategy sequences, for protecting critical data and non critical data respectively. The protection strategy of appropriate level is selected according to the accumulated lost slice rate fed back. Data of two different communication requirements are protected respectively, thus the system efficiency is improved.

The receiving end transmits the position information about the lost data back to the transmitting end, and the transmitting end resends the lost data. A mechanism of resending the lost data is advantageous for improving the reliability of the video stream communication and quality of service.

### BRIEF DESCRIPTION OF THE DRAWINGS

FIG. 1 is a schematic diagram showing the principle of the Tornado Erasure Codes;

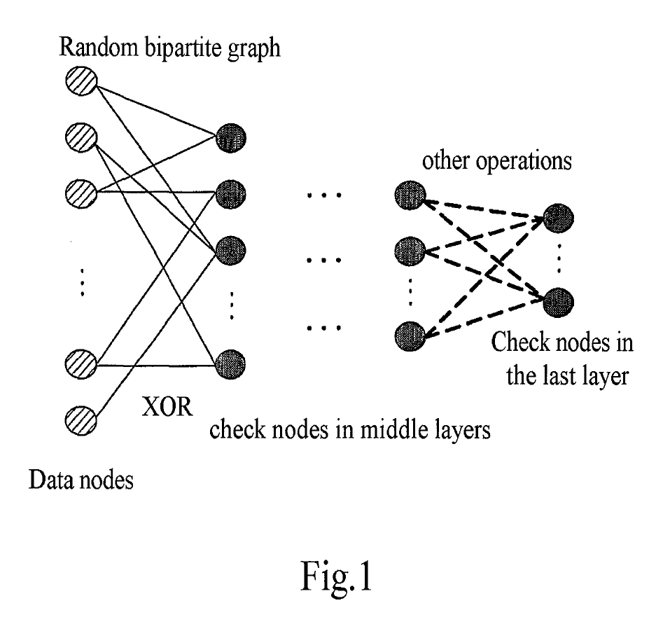

FIG. 2 is a diagram showing the flow chart of a method for protecting video transmission based on H.264 according to a first embodiment of the present invention.

### DETAILED DESCRIPTION OF THE EMBODIMENTS

To make objects, technical strategies and advantages of the present invention more apparent, a further detailed description will be given below in conjunction with the accompanying drawings hereinafter.

With respect to the situation that self adapting adjustment cannot be implemented according to the network communication status in the prior art, there is provided a method for video transmission with self adapting protection according to the invention, in which statistical analysis is performed on the current communication status and protection strategy is adjusted self adaptively. Firstly, different parameter configurations are given according to the influence of the performance of the protection method, so as to configure multilevel protection strategies with different protection capabilities. These protection strategies are selected to perform a high efficient protection under different communication statuses. Secondly, statistical analysis is performed on the network status and communication quality on the receiving end according to the communication states, and the result is transmitted back to the transmitting end; finally, adjustment is performed by the transmitting end according to the statistical information of the communication quality transmitted back, and the most suitable level of the protection strategy is selected.

The key of the present invention further lies in a method for performing the statistical analysis on the communication quality and a way for transmitting back the statistical information. With the information about the lost sequence number of H.264 NALU, statistical information about packet loss rate and position etc. may be obtained, and an extended SEI message structure of the payload in NALU is defined for bearing the statistical information, so that the statistical information may be transmitted from the receiving end to the transmitting end.

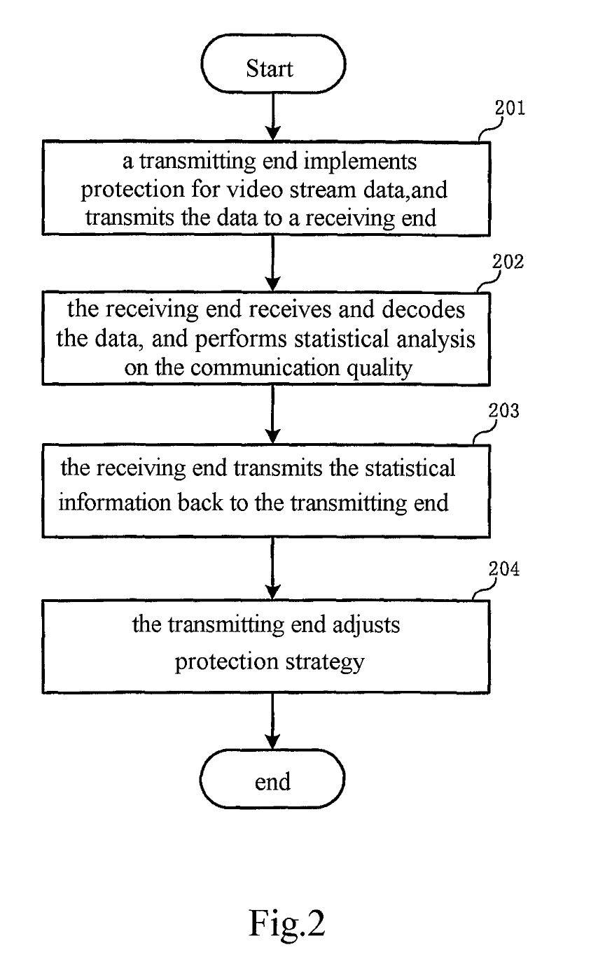

FIG. 2 shows a flow of the video transmission method according to the first embodiment of the present invention, which includes approximately four steps.

As shown in FIG. 2, in step 201, the transmitting end implements Tornado Erasure Codes protection for the video stream data to be transmitted, divides the data nodes and generates check nodes by calculation, and send the data nodes and the check nodes to the receiving end.

In the first embodiment of the present invention, Tornado Erasure Codes are adopted as the protection strategy, that is, video stream data is protected according to the above encoding and decoding method of the Tornado Erasure Codes. Parameters that need to be configured in the Tornado Erasure Codes include: the number of data nodes, the number of check nodes, the shrinking ratio, the number of layers of check nodes, Bipartite Graphs of each level for calculating check nodes. During the video stream communication, the transmitting end partitions video stream data into data nodes, generates check nodes according to the Tornado encoding method, and transmits the data nodes and the check nodes to the receiving end. The receiving end corrects errors according to the Tornado decoding method so as to obtain the video stream data.

Because factors such as the actual IP network bandwidth often vary and are instable, the fixed protection strategy may result in low efficiency, high bit error rate, etc. Therefore, in the first embodiment of the present invention, a series of protection strategies with different protection capabilities are preconfigured, which may be used to protect the video stream data under different communication qualities. It can be seen that the protection strategies in different levels are adaptive for the variation of the network communication quality. With such protection strategies, not only the requirements for the protection capability in deteriorated channels may be satisfied, but also the protection capability may be appropriately reduced when the signal is improved, as so to reduce the system overhead and spare processing resources as well as bandwidth resources.

In the first embodiment of the present invention, it is necessary to configure Tornado Erasure Codes with different parameters, so as to provide the protection strategies of different levels. As described above, the parameters that have influences on the protection performance of the Tornado Erasure Codes mainly include the number of data nodes, the number of check nodes and the random distribution of the node degree vectors on two sides of the bipartite graphs. For simplicity, the bipartite graphs are generally not uniform for the Tornado Codes with different capabilities, and the Tornado Erasure Codes protection strategies with different protection capabilities are generated with different number of data nodes and check nodes. According to the principle of the Tornado Erasure Codes, Tornado Erasure Codes with different code rates or redundancy rates may be determined with different number of data nodes and check nodes, thus provide different protection capabilities and system overheads.

It will be appreciated by those of ordinary skill in the art that in the present invention, other methods besides Tornado Erasure Codes may be adopted as the protection strategy, and different protection levels are configured according to the different strategy parameters, so that a protection capability may be selected and adjusted, so as to achieve the object of the present invention of implementing self adaptive protection according to the communication conditions without influence on the substance and scope of the present invention.

In step 202, the receiving end receives data and decodes the Tornado Erasure Codes to obtain the video stream data, and performs statistical analysis on the lost data to obtain the statistical information that characterizes the communication quality.

The transmitting end adjusts the protection strategy according to the status of the communication quality. Therefore, it is necessary to perform statistical analysis on the transmission. In the first embodiment of the present invention, the receiving end performs statistical analysis on the transmission based on the NALU sequence numbers of the H.264 video stream data. In the bidirectional video communication based on H.264, each of the terminals of the communication system has an encoder and a decoder. The NALUs are numbered in a sequence, i.e. the NALUs transmitted by the transmitting end have uniform sequence numbers. Thus, the receiving end is able to determine whether a NALU is lost according to the sequence numbers of the NALUs received. If the sequence numbers of the NALUs are discontinuous, it is indicated that there is a NALU loss, the missing NALU sequence number is the sequence number of the lost NALU, and the number of the sequence numbers is the number of the lost NALUs. By accumulating over a period, the total number of the lost NALUs within this period may be calculated, and the Accumulated Lost Slice Rate (ALSR) may be obtained by performing normalization for the total number of the lost NALUs with respect to the number of all the NALUs within this period. The receiving end may also transmit packet loss information back to the transmitting end directly, and the transmitting end performs the statistical analysis. By performing statistical analysis with the NALU sequence numbers, it may be ensured that the statistical information is precise, and further, existing data information is utilized directly, and no additional bearing overhead is required.

And in step 203, the receiving end transmits the statistical information and other data loss information back to the transmitting end via the extended SEI message.

When the receiving end obtains the statistical information about the transmission through the statistical analysis, the statistical information needs to be transmitted back to the transmitting end. In the first embodiment of the present invention, an extended SEI message structure is defined, which is specially used to bear the statistical information about the transmission transmitted back from the receiving end. After completing the statistical analysis, the information is written, by the receiving end, in the body of the extended SEI message that is specially defined, then in the SEI field of the code stream that is to be transmitted back by the receiving terminal, and transmitted back to the transmitting end. When the SEI is received, the transmitting end may obtain the statistical information directly, or obtain the ALSR by the statistical analysis, so as to establish a true perception mechanism of the transmitting end to the network packet loss rate.

As described above, the SEI message is also borne by a basic unit NALU of the H.264 code stream, wherein each SEI field includes one or more SEI message(s), and the SEI message is made up of SEI header information and an SEI payload. The SEI header information includes two code words, namely a load type and a load size. The length of the load type is not fixed. For example, when the load type is between 0 and 255, it is represented with one byte; when the load type is between 256 and 511, it is represented with two bytes between 0xFF00 and 0xFFFE, and so on, so a user may customize any kind of load types. In the existing H.264 standard, the type 0 to the type 18 are defined as special information, such as buffering cycle and image timing. Therefore, it can be seen that the SEI field defined in H.264 may store enough user customized information depending on the requirements. In the first embodiment of the present invention, an extended SEI message for bearing the statistical information is defined in the reserved SEI load type.

As described above, since the SEI message is an attached message, and the normal video communication is not influenced whether the SEI message exists or not, so the extended SEI message provided according to the present invention does not have influence on the existing video stream communication and has versatility. That is, if the terminals on the both sides of the communication support the strategy of the present invention, the statistical information about the packet loss may be transferred with the SEI message, so as to implement the self adaptive protection of different levels. If one party of the communication does not support the strategy of the present invention, the normal communication is not affected. Therefore, the extended SEI message customized does not affect the compatibility of the video communication system based on H.264. In addition, another advantage is that overhead may be reduced when the statistical data about packet loss is transferred with the SEI message. The SEI is a part of the H.264 code stream, therefore, when the statistical data about packet loss is borne with the H.264 code stream itself, it is unnecessary to open and maintain additional channels, so a high efficient transmission may be realized and the implementation is simple.

Finally, in step 204, the transmitting end adjusts the Tornado Erasure Codes according to the statistical information that is transmitted back, so as to adopt the protection strategy that is more suitable for the present transmission.

In the first embodiment of the present invention, the transmitting end finally needs to adjust the protection strategy according to the statistical information, in other words, the transmitting end needs to select the protection strategy of the appropriate level. Herein, the transmitting end also needs to preconfigure a set of judgment threshold values corresponding to the different protection levels, and set the thresholds for entering each level, then selecting a corresponding level according to the threshold interval where the ALSR is located. The accordingly established mechanism of performing statistical analysis, feeding back and adjustment may adapt itself to the requirements of the network transmission precisely and in time, so as to improve the protection capability.

In the second embodiment of the present invention, different protection strategy systems are adopted for the data with different importance on the basis of the above first embodiment. Considering the difference between the protection requirements of the critical data and non critical data, in the second embodiment of the present invention, in order to further improve the adaptability, two different protection strategy systems are configured, which are adapted to protect the critical data and non critical data respectively. Thus, two kinds of data with different communication requirements may be processed independently, the protection strategy may be selected according to the protection capability that is suitable for the respective requirements, and the efficiency of the system may be improved.

For example, Tornado codes of different levels are used as the protection strategy systems, whose protection levels are indicated with parameters n and 1, wherein n denotes the number of data nodes, 1 denotes the number of check nodes. TN(n+1, n) denotes the Tornado codes protection strategy determined by the parameters n and 1. Therefore, the protection strategy sequence corresponding to the critical data is: TNK(n₀+1₀, n₀), TNK(n₁+1₁, n₁), . . . , TNK(n_{L-1}+1_{L-}1, n_{L-1}); and the protection strategy sequence corresponding to the non critical data is: TNNK(n₀+1₀, n₀), TNNK(n₁+1₁, n₁), . . . , TNNK(n_{L-1}+1_{L-1}, n_{L-1}). The threshold sequence 0<G₁, G₂, . . . , G_{L-1}<1 is configured, which is adopted to determine and select the protection level. When the transmitting end adjusts the protection strategy, the following operations are performed according to the relationship between the ALSR and the threshold values G₁, G₂, . . . , G_{L-1}:

If 0<ALSR<G1, TNK(n₀+1₀, n₀) is adopted to protect the critical data, and TNNK(n₀+1₀, n₀) is adopted to protect the non critical data;

If Gᵢ<ALSR<Gᵢ₊₁, i=1, 2, . . . , L−2, TNK(nᵢ+1ᵢ, nᵢ) is adopted to protect the critical data, and TNNK(nᵢ+1ᵢ, nᵢ) is adopted to protect the non critical data;

If G_{L-1}<ALSR<1, TNK(n_{L-1}+1_{L-1}, n_{L-1}) is adopted to protect the critical data, and TNNK(n_{L-1}+1_{L-1}, n_{L-1}) is adopted to protect the non critical data.

In the third embodiment of the present invention, the transmitting end resends the information according to the information about the lost data that is transmitted back by the receiving end on the basis of the above second embodiment. When performing the statistical analysis on the information of the lost NALU, the receiving end simultaneously obtains the position information of the image frame that is included in the lost NALU, wherein the position information includes the sequence number of the frame where the lost NALU is located and the position in the frame. The receiving end transmits the position information back to the transmitting end; then the transmitting end is able to go to the corresponding video stream data and resends the data. In the real-time video communication, the video stream data with a too long delay is valueless; however, for some service requirements or in a mechanism, the data with a delay may still have value. For example, when the video communication has a relative large buffer range, as long as the delayed video stream data still falls in the buffer zone, such data may be used to avoid interrupting the play of the video stream. Therefore, the resending mechanism described in the third embodiment has an important value for improving the reliability of the video stream communication and the quality of service.

It will be appreciated by those of ordinary skill in the art that in further embodiments of the invention, the receiving end may perform statistical analysis based on other information of the video stream data received except the NALU sequence number, so as to obtain the statistical value indicating the communication quality. The receiving end may also adopt other bearing fields except SEI to transfer the statistical information. When the transmitting end obtains the feedback of the statistics about the communication quality, a self adaptive adjustment may be implemented, so as to achieve the object of the present invention, without influencing on the substance and scope of the present invention.

1. A method for protecting video transmission based on H.264, comprising:
protecting, by a transmitting end, video stream data according to a protection strategy, and transmitting the video stream data to a receiving end;
receiving, by the receiving end, the video stream data, obtaining information about communication quality according to the video stream data, and transmitting the information about communication quality to the transmitting end;
receiving, by the transmitting end, the information about communication quality, and adjusting the protection strategy accordingly.

2. The method for protecting video transmission based on H.264 according to claim 1, wherein the obtaining information about communication quality comprises: abstracting, by the receiving end, sequence numbers of network abstraction layer units from the video stream data received, performing a statistical analysis and obtaining an accumulated lost slice rate, which is used as statistical information for indicating the information about the communication quality.

3. The method for protecting video transmission based on H.264 according to claim 1, wherein the obtaining information about communication quality comprises: abstracting, by the receiving end, sequence numbers of network abstraction layer units from the video stream data received, taking a sequence number of a lost network abstraction layer unit as the information about communication quality; and
in the process of receiving, by the transmitting end, the information about communication quality, and adjusting the protection strategy accordingly, the transmitting end calculates and obtains an accumulated lost slice rate according to the sequence number of the lost network abstraction layer unit, and adjusts the protection strategy according to the accumulated lost slice rate.

4. The method for protecting video transmission based on H.264 according to claim 1 wherein the transmitting end configures protection strategy systems of different levels, the adjusting in the process of receiving, by the transmitting end, the information about communication quality, and adjusting the protection strategy accordingly comprises: selecting and implementing the protection strategy of a corresponding level according to the information about communication quality.

5. The method for protecting video transmission based on H.264 according to claim 1, wherein the transmitting end configures a threshold sequence of the accumulated lost slice rate and in the process of receiving, by the transmitting end, the information about communication quality and adjusting the protection strategy accordingly, the protection strategy is adjusted according to a comparison relationship between the accumulated lost slice rate and the threshold sequence of the accumulated lost slice rate.

6. The method for protecting video transmission based on H.264 according to claim 1, wherein the transmitting the information about communication quality to the transmitting end comprises: defining, by the receiving end, extended supplemental enhancement Information for carrying the information about communication quality filling the information about communication quality in the extended supplemental enhancement information and transmitting the extended supplemental enhancement information back to the transmitting end.

7. The method for protecting video transmission based on H.264 according to claim 4, wherein the protection strategy systems comprise: a first protection strategy sequence, adapted to protect critical data of the video stream data; and a second protection strategy sequence adapted to protect less critical data of the video stream data.

8. The method for protecting video transmission based on H.264 according to claim 4, wherein the protection strategy adopts Tornado Erasure Codes, and the protection strategies of different levels correspond to the Tornado Codes with different parameters.

9. The method for protecting video transmission based on H.264 according to claim 4, wherein the transmitting end configures a threshold sequence of an accumulated lost slice rate, the information about communication quality is the accumulated lost slice rate or a sequence number of a lost network abstraction layer unit; the adjusting in the process of receiving, by the transmitting end, the information about communication quality, and adjusting the protection strategy accordingly comprises: selecting and implementing the protection strategy of the corresponding level according to the comparison relationship between the accumulated lost slice rate and the threshold sequence of the accumulated lost slice rate.

10. The method for protecting video transmission based on H.264 according to claim 3, wherein the process of receiving, by the receiving end, the video stream data, obtaining information about communication quality according to the video stream data and transmitting the information about communication quality to the transmitting end further comprises: obtaining by the receiving end, position information about lost video stream data through statistical analysis according to received sequence numbers of network abstraction layer units of the video stream data, and transmitting the position information back to the transmitting end; and
the process of receiving by the transmitting end, the information about communication quality and adjusting the protection strategy accordingly further comprises: resending, by the transmitting end, the lost video stream data to the receiving end according to the position information about the lost video stream data.

11. The method for protecting video transmission based on H.264 according to claim 2, wherein the transmitting end configures a threshold sequence of the accumulated lost slice rate, and in the process of receiving by the transmitting end, the information about communication quality, and adjusting the protection strategy accordingly, the protection strategy is adjusted according to a comparison relationship between the accumulated lost slice rate and the threshold sequence of the accumulated lost slice rate.

12. The method for protecting video transmission based on H.264 according to claim 3, wherein the transmitting end configures a threshold sequence of the accumulated lost slice rate, and in the process of receiving, by the transmitting end, the information about communication quality, and adjusting the protection strategy accordingly, the protection strategy is adjusted according to a comparison relationship between the accumulated lost slice rate and the threshold sequence of the accumulated lost slice rate.

13. The method for protecting video transmission based on H.264 according to claim 4, wherein the transmitting end configures a threshold sequence of the accumulated lost slice rate, and in the process of receiving, by the transmitting end, the information about communication quality, and adjusting the protection strategy accordingly, the protection strategy is adjusted according to a comparison relationship between the accumulated lost slice rate and the threshold sequence of the accumulated lost slice rate.

14. The method for protecting video transmission based on H.264 according to claim 2, wherein the transmitting the information about communication quality to the transmitting end comprises: defining, by the receiving end, extended supplemental enhancement Information for carrying the information about communication quality, filling the information about communication quality in the extended supplemental enhancement information and transmitting the extended supplemental enhancement information back to the transmitting end.

15. The method for protecting video transmission based on H.264 according to claim 3, wherein the transmitting the information about communication quality to the transmitting end comprises: defining, by the receiving end, extended supplemental enhancement Information for carrying the information about communication quality, filling the information about communication quality in the extended supplemental enhancement information and transmitting the extended supplemental enhancement information back to the transmitting end.

16. The method for protecting video transmission based on H.264 according to claim 7, wherein the protection strategy adopts Tornado Erasure Codes, and the protection strategies of different levels correspond to the Tornado Codes with different parameters.
